(19) United States
(12) Patent Application Publication
(10) Pub. No.: US 2006/0234668 A1
(43) Pub. Date: Oct. 19, 2006

(54) Communication semiconductor integrated circuit

(76) Inventors: Takeshi Uchitomi, Maebashi (JP); Takao Okazaki, Hamura (JP); Sakae Chida, Asaka (JP); Yasuo Shima, Ome (JP); Gary Smith, Swindon (GB)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/393,704

(22) Filed: Mar. 31, 2006

(30) Foreign Application Priority Data
Mar. 31, 2005 (GB) 0506556.0

(51) Int. Cl. H04B 1/06; H04B 1/28; H04B 7/00

(52) U.S. Cl. 455/333; 455/252.1

(57) ABSTRACT

The communication semiconductor integrated circuit includes serial-signal processing circuits having low-pass filters and variable gain amplifier circuits cascade-connected in series. The low-pass filters constituting the serial-signal processing circuit each include a variable capacitance circuit composed of capacitance elements and switching elements connected in series to the capacitance elements, respectively, and capable of selecting the capacitance elements to change capacitance of the low-pass filter. A reference clock signal is supplied to the circuit containing the low-pass filters upon turning on of a power supply, for example, to determine a deviation of a delay time in the circuit to a design value and on and off states of the switching elements of the variable capacitance circuit are set so that the deviation of the delay time is minimized.

### INCORPORATION BY REFERENCE

The present application claims priority from British patent application No. 0506556.0 filed on Mar. 31, 2005, the content of which is hereby incorporated by reference into this application.

### BACKGROUND OF THE INVENTION

The present invention relates to a calibration technique of a low-pass filter in a high-gain amplifier circuit having a plurality of low-pass filters and a plurality of variable gain amplifier circuits cascade-connected in series and more particularly to a technique effectively applicable to a communication semiconductor integrated circuit mounted in wireless or radio communication apparatuses such as, for example, portable telephones and including a high-gain amplifier circuit which amplifies a high-frequency reception signal.

Wireless communication apparatuses (mobile communication apparatuses) such as automobile telephones and portable telephones use a high-gain amplifier circuit including a plurality of low-pass filters and a plurality of variable gain amplifiers cascade-connected in series in order to amplify a weak received signal to a predetermined level that a baseband circuit can process while removing noise and unnecessary frequency signals.

Wireless communication systems such as portable telephones include a receiving circuit which down-converts a high-frequency received signal to a baseband signal in the audio-frequency band and subjects it to orthogonal demodulation to divide it into I and Q signals and further amplifies the signals to the level suitable for a base band circuit. Such a receiving circuit is required to have the characteristic of suppressing disturbance waves and reducing distortion in the received signal.

Further, in the recent portable telephones of the GSM system (global system for mobile communication), a system is being made practical in which a mode named an enhanced data rates for GSM evolution (EDGE) having the 3π/8 rotating 8-PSK (phase shift keying) modulation mode for modulating a phase component and an amplitude component of a carrier wave is provided in addition to the Gaussian filtered minimum shift keying (GMSK) modulation mode for modulating the phase component of the carrier wave and the modulation modes are changed over to make communication.

In addition, multi-mode portable telephones which can make wireless communication by a plurality of systems such as the GSM system and the W-CDMA (wideband code division multiple access) system are being developed. The receiving circuit used in such a wireless communication apparatus is required to have more severe conditions for the characteristic of suppressing distortion in the received signal and disturbance wave as compared with the apparatuses which can make wireless communication only by the GSM system. Further, heretofore, there is disclosed an invention concerning a high-gain amplifier circuit in which DC offset in a variable gain amplifier is cancelled to reduce distortion of a received signal (refer to U.S. Patent Publication No. 2003/0228852).

### SUMMARY OF THE INVENTION

There is an error vector magnitude (EVM) as a measure of indicating an error between an actual signal demodulated with dispersion in the filtering characteristic of the receiving circuit of the wireless communication apparatus and an ideally demodulated signal. When the EVM value is increased, the bit error rate is deteriorated and the reception sensitivity is degraded. The filter of the receiving circuit dealing with the phase modulation and the amplitude modulation in the EDGE mode is required to have the following characteristics.

Since the modulation system (EDGE mode) which makes the phase modulation and the amplitude modulation concurrently is provided in addition to the phase modulation (GMSK modulation mode) in the conventional GMSK system, the flat filtering characteristic having a small EVM value for variation in an amplitude (i.e. small amplitude error) in a passing band is required. FIG. 10 shows measured results of the filtering characteristic by simulation implemented to the high-gain amplifier circuit to which the present invention is not applied. FIG. 11 also shows measured results of EVM versus amplitude error in a passing band.

In FIG. 10, curve A represents a filtering characteristic for a design value and curves B1 and B2 represent filtering characteristics in case where a product RC of a resistance value of a resistance element and a capacitance value of a capacitance element of a low-pass filter is deviated by ±20% from the design value, respectively. The amplitude error in the abscissa of FIG. 11 corresponds to a difference between the filtering characteristics A and B1 or B2 of FIG. 10. It is understood from FIG. 11 that the sensitivity of the EVM to the amplitude error is influenced by the frequency below 135 kHz in the passing band. Accordingly, it is understood that it is important to reduce dispersion in the product RC in order to obtain the flat filtering characteristic having a small EVM value in the passing band. Further, the deterioration degree of the bit error rate due to the deteriorated EVM depends on the performance of the used baseband circuit.

Further, in the EDGE mode, since the phase modulation and the amplitude modulation are made concurrently, a signal peak is increased by about 3 dB as compared with the GMSK modulation mode in which only the phase modulation is made. Further, since the fading that two waves having different phases become stronger and weaker due to the reciprocal action when the two waves are combined is generated to thereby increase the signal strength by about 8 dB, the high-gain amplifier circuit is required to make dispersion in the filtering characteristic in the passing band smaller as compared with the conventional method where only the phase modulation is made. Hereafter, it is expected that the dynamic range of an A-D converter provided at the succeeding stage of the high-gain amplifier circuit is made small by lowering a voltage applied to the baseband circuit, although there is an increased possibility that the bit error rate is deteriorated as far as the EVM value varied due to dispersion in the filtering characteristic in production is not improved.

It is an object of the present invention to provide a communication semiconductor integrated circuit (high-frequency IC) which can calibrate dispersed filtering characteristic of a high-gain amplifier circuit for processing a reception signal even if the filtering characteristic is dispersed due to the manufacturing process.

It is another object of the present invention to provide a communication semiconductor integrated circuit (high-frequency IC) including a receiving circuit which has a satisfactory EVM value and can improve the bit error rate in communication using the EDGE mode.

The above and other objects and novel features of the invention will be apparent from the following description of the specification taken in connection with the accompanying drawings.

An outline of representative aspects of the present invention is as follows.

In a communication semiconductor integrated circuit (high-frequency IC) including a serial-signal processing circuit (high-gain amplifier circuit) having a plurality of low-pass filters and a plurality of variable gain amplifier circuits cascade-connected alternatively in series, the low-pass filters constituting the serial-signal processing circuit each include as capacitance thereof a variable capacitance circuit composed of a plurality of capacitance elements and switching elements connected in series to the capacitance elements, respectively. A reference clock signal is supplied to the circuit containing the low-pass filters upon turning on of a power supply, for example, to determine a deviation of a delay time in the circuit to a design value and on and off states of the switching elements of the variable capacitance circuit are set so that the deviation of the delay time is minimized.

According to the above-mentioned measure, since capacitance of the filter is adjusted so that the deviation of the delay time is minimized by means of the variable capacitance circuit even if capacitance values of the capacitance elements of the filter are dispersed due to manufacturing process, dispersion in the frequency characteristic of the filter can be reduced to thereby increase the suppression degree of disturbance wave contained in the received signal and improve the EVM value.

Preferably, when the low-pass filter uses a filter including two or more capacitances or capacitance elements, each of the capacitances is constituted by a variable capacitance circuit including a plurality of capacitance elements and switching elements. The capacitance value of the filter is adjusted so that on and off states of the switching elements of the respective variable capacitance circuits are set to be identical by a common control signal. Consequently, increase of the circuit scale thereof can be suppressed as compared with the case where circuits for generating a control signal of the switching elements are provided separately.

Effects attained by representative aspects of the present invention are as follows.

According to the present invention, there can be realized the communication semiconductor integrated circuit (high-frequency IC) including a receiving circuit which can make calibration and improve the bit error rate in communication using the EDGE mode and has a satisfactory EVM value even if the filtering characteristic of the high-gain amplifier circuit for processing the received signal is dispersed due to manufacturing process.

### BRIEF DESCRIPTION OF THE DRAWINGS

FIG. 1 is a block diagram schematically illustrating an embodiment of a high-gain amplifier circuit having the calibration function of capacitance elements according to the present invention and a receiving circuit of a high-frequency signal to which the high-gain amplifier circuit is applied;

FIG. 2 is a block diagram illustrating a configuration example of a calibration circuit in the high-gain amplifier circuit of the embodiment;

FIGS. 3A and 3B are schematic diagrams illustrating examples of primary and secondary low-pass filters constituting the high-gain amplifier circuit of the embodiment, respectively;

FIG. 4 is a circuit diagram illustrating a concrete example of a capacitance-adjustable low-pass filter used in the high-gain amplifier circuit of the embodiment;

FIG. 5 is a flow chart showing a procedure of calibration in the high-gain amplifier circuit of the embodiment;

FIG. 6 is a timing chart showing timing of signals upon calibration in the high-gain amplifier circuit of the embodiment;

FIG. 7 is a diagram explaining how to decide a capacitance value in the calibration circuit of the embodiment;

FIGS. 8A and 8B schematically illustrate modification examples of the low-pass filter constituting the high-gain amplifier of the embodiment;

FIG. 9 is a block diagram schematically illustrating an example of a communication semiconductor integrated circuit (high-frequency IC) including a receiving circuit to which the high-gain amplifier circuit having the calibration function of the embodiment is applied and a wireless communication system using it;

FIG. 10 is a characteristic diagram showing measured results of the filtering characteristic by simulation implemented to the high-gain amplifier circuit to which the present invention is not applied; and

FIG. 11 is a characteristic diagram showing measured results of EVM versus amplitude error in a passing band by simulation implemented to the high-gain amplifier circuit to which the present invention is not applied.

### DESCRIPTION OF THE EMBODIMENTS

Embodiments of the present invention are now described with reference to the accompanying drawings.

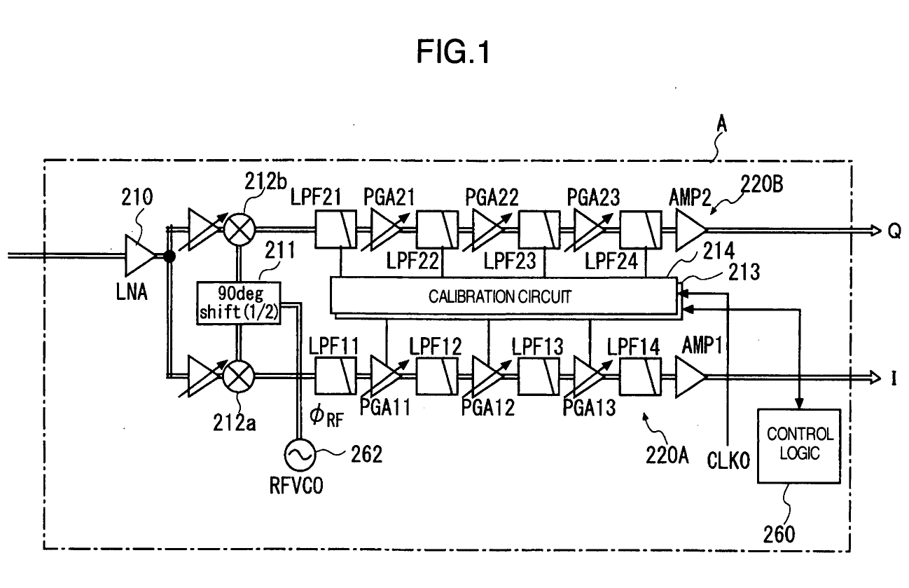

FIG. 1 schematically illustrates an embodiment of a high-gain amplifier circuit (PGA) according to the present invention and a receiving circuit of a high-frequency signal to which the high-gain amplifier circuit is applied. In FIG. 1, a circuit enclosed by one-dot chain line A is formed as a semiconductor integrated circuit on a single semiconductor chip made of monocrystalline silicon.

The receiving circuit of the embodiment includes a low-noise amplifier 210 which amplifies a reception signal received by an antenna, a frequency dividing and phase shifting circuit 211 which frequency-divides a local oscillation signal φRF generated by a high-frequency oscillation circuit (RFVCO) 262 and generates orthogonal signals having phases shifted by 90° from each other, mixer circuits 212a and 212b which mix the received signal amplified by the low-noise amplifier 210 with the orthogonal signals generated by the frequency dividing and phase shifting circuit 211 to thereby make demodulation and down-conversion of I and Q signals in the audio-frequency band, common high-gain amplifier portions 220A and 220B which amplify the demodulated I and Q signals to supply them to a baseband circuit (LSI) not shown, an offset cancel circuit 213 which cancels input DC offset in gain control amplifiers PGA of the high-gain amplifier portions 220A and 220B, a calibration circuit 214 which calibrates dispersion in capacitance of low-pass filters LPF of the high-gain amplifier portions 220A and 220B, and a control logic (controller) 260 which controls the whole receiving circuit.

The receiving circuit of the embodiment is characterized by the provision of the calibration circuit 214. The offset cancel circuit 213 can use the circuit similar to the offset cancel circuit disclosed in U.S. Patent Publication No. 2003/0228852 filed before by the present applicant, for example, while the offset cancel circuit 213 can be used separately from the calibration circuit of the present invention and accordingly a drawing illustrating detailed configuration of the offset cancel circuit 213 is omitted.

The high-gain amplifier portion 220A includes a plurality of low-pass filters LPF11, LPE12, LPF13, LPF14 and a plurality of gain control amplifiers PGA11, PGA12, PGA13 connected alternately in series and an amplifier AMP1 connected in the final stage thereof and amplifies the demodulated I signal to a predetermined amplitude level while removing unnecessary waves. Similarly, the high-gain amplifier portion 220B also includes a plurality of low-pass filters LPF21, LPF22, LPF23, LPF24 and a plurality of gain control amplifiers PGA21, PGA22, PGA23 connected alternately in series and an amplifier AMP2 connected in the final stage thereof and amplifies the demodulated Q signal to a predetermined amplitude level.

The offset cancel circuit 213 includes, although not shown in detail, analog-to-digital (A-D) converter circuits (ADC) which are disposed in a corresponding manner to the gain control amplifiers PGA11 to PGA23 and convert differences between output voltages thereof in the state where short circuits are formed between input terminals into digital signals, digital-to-analog (D-A) converter circuits (DAC) which generate input offset voltages by which DC offsets in outputs of the corresponding gain control amplifiers PGA11 to PGA23 are canceled on the basis of the conversion results of the A-D converter circuits and supply them to differential inputs, and a control circuit which controls the A-D converter circuits (ADC) and the D-A converter circuits (DAC) to perform offset cancel operation.

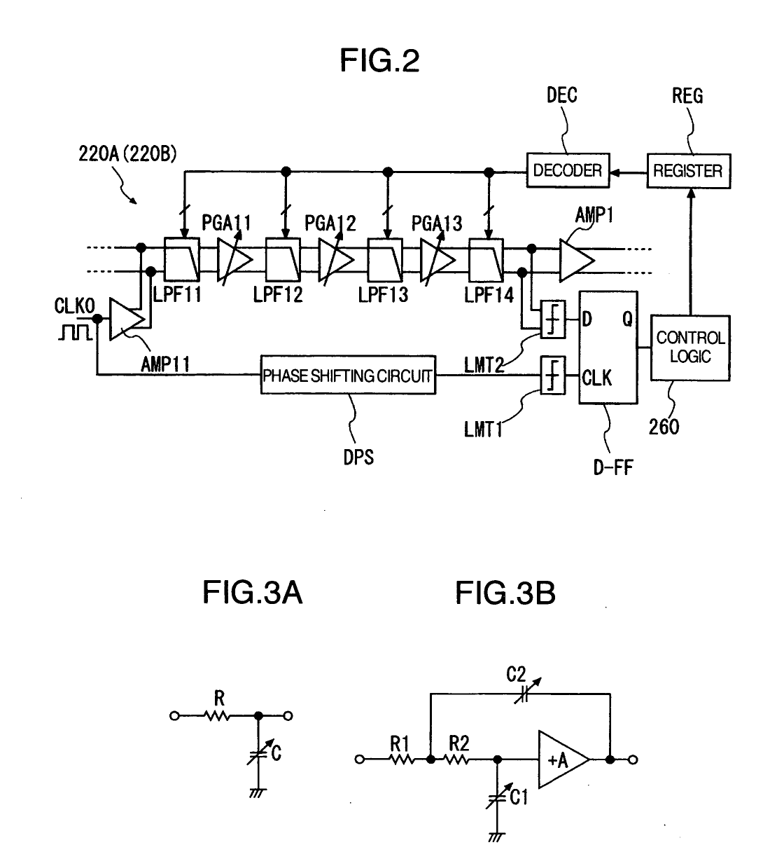

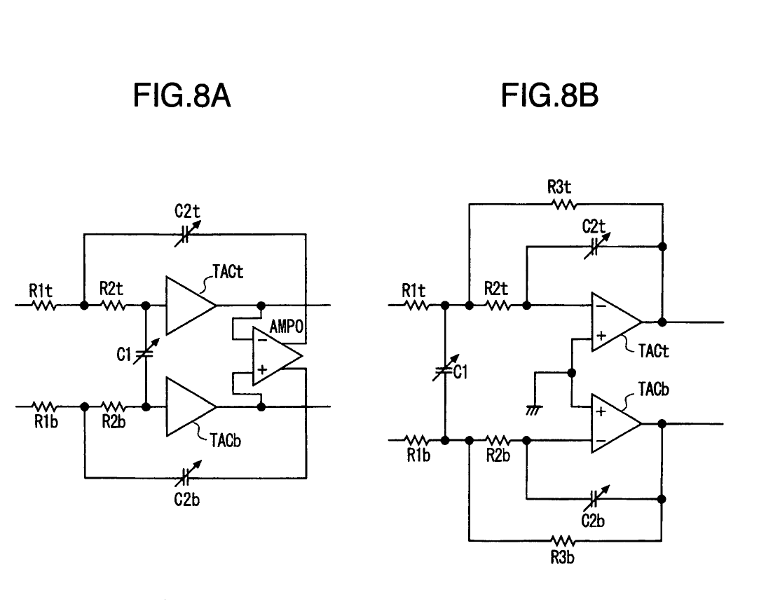

FIG. 2 illustrates a concrete example of the calibration circuit 214 and FIGS. 3A and 3B illustrate concrete examples of the low-pass filter. In the embodiment, low-pass filters LPF11 and LPF12 at the first stage use a first-order RC filter as shown in FIG. 3A and low-pass filters LPF12 to LPFl4 and LPF22 to LPF24 at the second stage to the fourth stage use a second-order Sallen-key filter as shown in FIG. 3B. LPF14 and LPF24 may also consist of multi-feedback type filter as shown in FIG. 8B. The filter shown in FIG. 8B will be described in detail later.

The first-order RC filter shown in FIG. 3A has the filtering characteristic having a cut-off frequency fc expressed by fc=½πRC and the second-order Sallen-key filter shown in FIG. 3B has the filtering characteristic expressed by fc=½π√(R1·R2·C1·C2) and Q=√(R1·R2·C1·C2)/(1−A) ·R1·C2+C1·(R1+R2). The low-pass filters used in the calibration circuit 214 of FIG. 2 use variable capacitance elements as the capacitance elements C, C1 and C2 as shown in FIGS. 3A and 3B to thereby make it possible to adjust dispersion in characteristics of elements in production.

The calibration circuit 214 includes a single-input and differential-output type amplifier AMP11 which supplies a reference clock signal CLK0 to the low-pass filter LPF11 at the first state, a digital phase shifting circuit DPS which delays the reference clock signal CLK0 by the time (e.g. 5 μsec.) corresponding to a delay time of the high-gain amplifier circuit, a limiter circuit LMT1 which limits an amplitude of an output signal of the digital phase shifting circuit to shape the waveform thereof, a limiter circuit LMT2 which limits an amplitude of the signal passing through the low-pass filter LPF14 at the final stage to shape the waveform thereof, a D-type flip-flop D-FF which is supplied to a data input terminal thereof with an output of the limiter circuit LMT2 and to a clock terminal thereof with an output of the limiter circuit LMT1 to make latch operation, a register REG which holds a control code, and a decoder DEC which decodes the control code to generate a change-over control signal for a switching element.

An output of the flip-flop D-FF is supplied to the control logic 260 and the control logic 260 decides which phase of the outputs of the limiter circuits LMT1 and LMT2 is advanced and generates a control code for changing over capacitance values of variable capacitance circuits in the low-pass filters LPF11 to LPF14 and LPF21 to LPF24 to set it in the register REG.

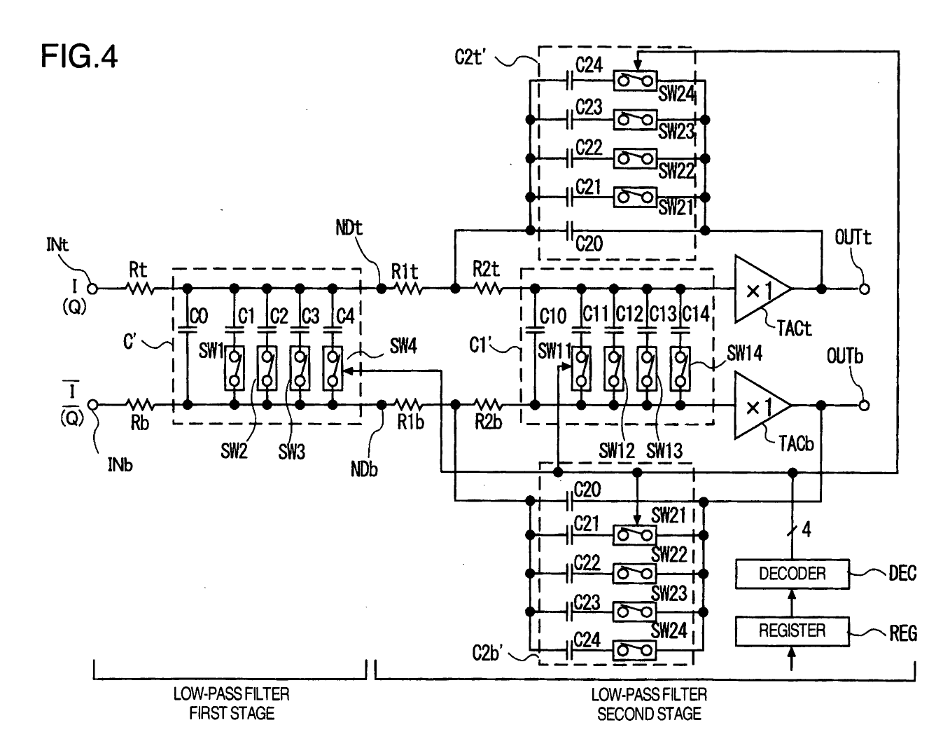

FIG. 4 illustrates a concrete circuit example of filters at the first and second stages of the low-pass filters LPF11 to LPF14 and LPF21 to LPF24 used at the first to fourth stages. In the embodiment, filters at the third stages have the same configuration as that of the filter at the second stage and filter at the fourth stage have the same configuration as that of the filter at the second stage or the filter shown in FIG. 8B, and accordingly the filters are not shown.

The high-gain amplifier circuit of the embodiment amplifies demodulated I and Q signals as differential signals I, /I (Q, /Q) having phases shifted by 180 degrees from each other and accordingly each filter includes a pair of input terminals INt, INb and a pair of output terminals OUTt, OUTb. A resistor Rt of the filter at first stage, resistors R1t, R2t of the filter at second stage and a transistor amplifier circuit TACt are connected in series between the input terminal INt and the output terminal OUTt on the positive phase side. Further, a resistor Rb of the filter at first stage, resistors R1b, R2b of the filter at second stage and a transistor amplifier circuit TACb are connected in series between the input terminal INb and the output terminal OUTb on the negative phase side.

In the embodiment, the transistor amplifier circuits TACt, TACb use an emitter follower of bipolar transistors but may use a differential amplifier circuit. In this case, the differential amplifier circuit has an output voltage fed back to an inverted input terminal thereof to be operated as a voltage follower.

A capacitance circuit C′ corresponding to the variable capacitance C shown in FIG. 3A includes a plurality of capacitance elements C0, C1, C2, C3, C4 and a plurality of switching elements SW1, SW2, SW3, SW4 connected in series to the capacitance elements C1, C2, C3, C4, respectively. Although not limited, the capacitance elements C0 to C4 are formed to have capacitance values weighted by the nth power of 2 and the capacitance value of C0+C4 is set to be a design value when dispersion in the product RC caused by dispersion in characteristics of elements in production is 0%. It is designed that C0 has capacitance value equal to 80% of the design value, C1 has capacitance value equal to 1/32 of C0 (2.5% of design value), C2 has capacitance value equal to 1/16 of C0 (5% of design value), C3 has capacitance value equal to ⅛ of C0 (10% of design value) and C4 has capacitance value equal to ¼ of C0 (20% of design value).

The switches SW1 to SW4 are turned on and off in accordance with an output (capacitance calibration bits) of the decoder DEC and a combined capacitance value of the capacitance element(s) connected to the turned-on switch(es) and the capacitance element C0 is the total capacitance value of the circuit so that the capacitance of the circuit can be calibrated in units of 2.5% in the range of −20.0 to +17.5% of dispersion in characteristics of elements in production.

A capacitance circuit C1′ corresponding to the variable capacitance C1 shown in FIG. 3B includes a plurality of capacitance elements C10, C11, C12, C13, C14 connected between input terminals of the transistor amplifier circuits TACt, TACb and a plurality of switching elements SW11, SW12, SW13, SW14 connected in series to the capacitance elements C11 to C14, respectively. Although not limited, the capacitance elements C10 to C14 are formed to have capacitance values weighted by the nth power of 2 similarly to the capacitance circuit C′ and the switches SW11 to SW14 are turned on and off in accordance with the output of the decoder DEC similarly to the switches SW1 to SW4. A combined capacitance value of the capacitance element(s) connected to the turned-on switch(es) and the capacitance element C10 is the total capacitance value of the circuit so that the capacitance of the circuit can be calibrated in units of 2.5% in the range of −20.0 to +17.5% of dispersion in characteristics of elements in production. A definition of “n” will be given later.

The switches SW11 to SW14 may be turned on and off separately from the switches SW1 to SW4, although capacitance values of the capacitance elements are dispersed similarly within the same semiconductor chip and accordingly even if the switches SW11 to SW14 and the switches SW1 to SW4 are turned on and off in accordance with the same output of the decoder, the capacitance values can be set to reduce dispersion in the capacitance values. In addition, in the filter of the embodiment, even if resistance values of resistance elements constituting the filter are dispersed, the dispersion in the resistance values can be calibrated by adjusting the capacitance values of capacitance circuits C′, C2t′, C2b′ and C1′ as the product RC by means of the calibration system described later.

Capacitance circuits C2t′ and C2b′ corresponding to the variable capacitance C2 shown in FIG. 3B each include a plurality of capacitance elements C20, C21, C22, C23, C24 and a plurality of switching elements SW21, SW22, SW23, SW24 connected in series to the capacitance elements C21 to C24, respectively. Although not limited, the capacitance elements C20 to C24 are formed to have capacitance values weighted by the nth power of 2 and the capacitance value of C20+C24 is set to be a design value when dispersion in the product RC caused by dispersion in characteristics of elements in production is 0%. It is designed that C20 has capacitance value equal to 80% of the design value, C21 has capacitance value equal to 1/32 of C20 (2.5% of design value), C22 has capacitance value equal to 1/16 of C20 (5% of design value), C23 has capacitance value equal to ⅛ of C20 (10% of design value) and C24 has capacitance value equal to ¼ of C20 (20% of design value). In other words, in the embodiment, the minimum correction unit of capacitance C21 of the variable capacitance C2 is given a weight coefficient of the 0th power of 2, C22 the 1st power of 2 on capacitance C21, C23 the 2nd power of 2 on capacitance C21, C24 the 3rd power of 2 on capacitance C21 and C20 the 5th power of 2 on capacitance C21 (n=0, 1, 2, 3, 5). However, the present invention is not limited thereto.

The switches SW21 to SW24 are turned on and off in accordance with the output of the decoder DEC similarly to the switches SW11 to SW14 and a combined capacitance value of the capacitance element(s) connected to the turned-on switch(es) and the capacitance element C20 is the total capacitance value of the circuit so that the capacitance of the circuit can be calibrated in units of 2.5% in the range of −20.0 to +17.5% of dispersion in characteristics of elements in production.

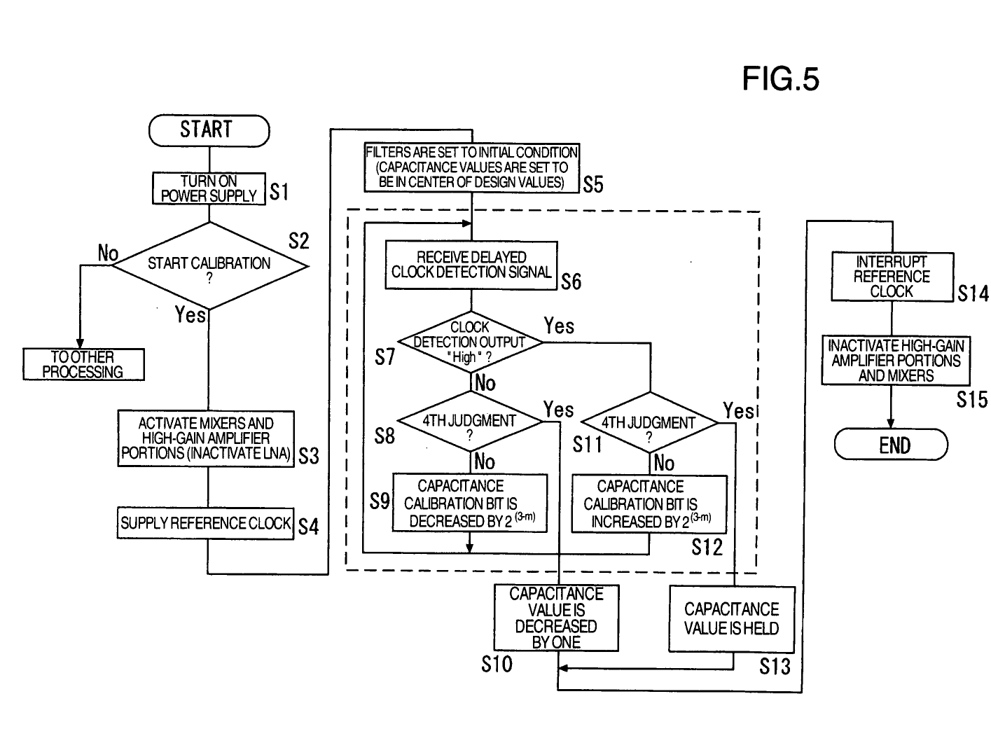

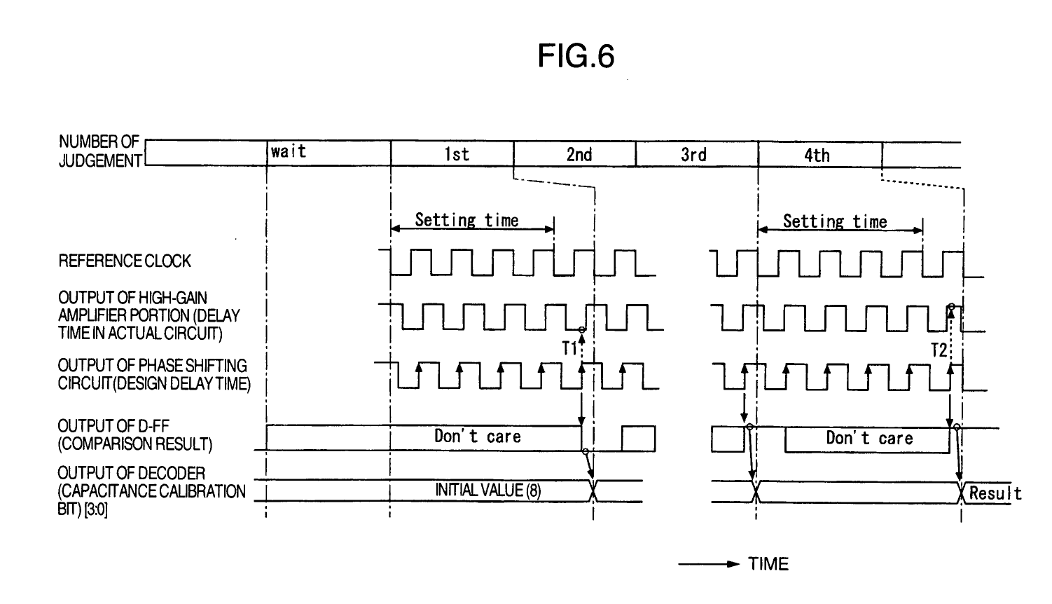

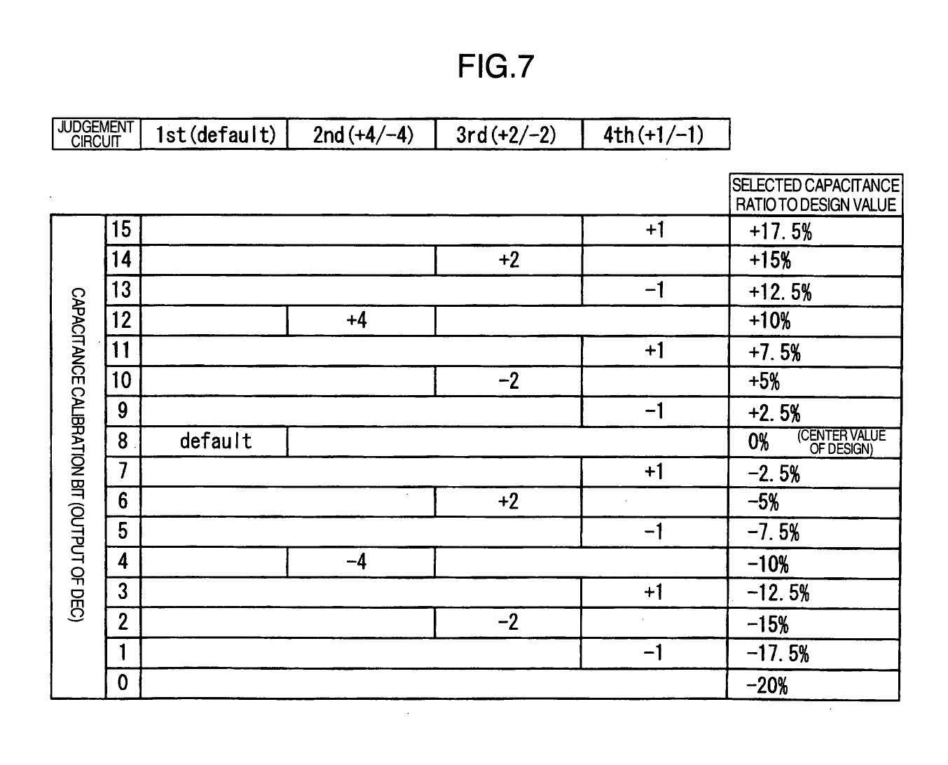

Referring now to the flow chart of FIG. 5 and the timing chart of FIG. 6, the calibration procedure of the low-pass filters in the high-gain amplifier circuit of the embodiment is described. In the embodiment, the calibration is once made by the control logic 260 when the power supply is turned on. As described below, in the embodiment, the calibration is made so that optimum capacitance values are set by means of a so-called binary search method (refer to FIG. 7). The calibration bit value of FIG. 7 corresponds to a capacitance value to be calibrated. The calibration bit value is generated by the control logic 260 to be supplied through the register (REG) to the decoder (DEC), which produces a signal for turning on and off the switches so that the capacitance value is selected in accordance with the calibration bit value.

As shown in FIG. 5, after the power supply is turned on (step S1), the control logic 260 receives a command for instructing the control logic to start the calibration from, for example, a baseband circuit (step S2). When the calibration is started, the control logic 260 activates the mixers 212a, 212b at the front stage and the high-gain amplifier portions 220A, 220B (step S3). At this time, however, the low-noise amplifier 210 is inactivated to be set to the stopped state. Then, the reference clock CLK0 is supplied to the calibration circuit 214 and the low-pass filters are set to the initial state (steps S4, S5). More particularly, the switches SW4, SW14, SW24 of FIG. 4 are turned on and other switches are turned off so that capacitance values of the variable capacitance elements in the filters are set to be in the center of the design values.

Then, in step S6, the control logic 260 receives a delayed clock detection signal, that is, the output of the flip-flop D-FF and judges whether the output is high level or not (step S7). When the judgment result is “No”, that is, when the detection output is low level, it is understood that the phase of the clock passing through the phase shifting circuit DPS is more advanced than the phase of the clock passing through the filters LPF11 to LPF14 as shown at time T1 of FIG. 6.

In this case, the control logic 260 decides whether the above judgment is the fourth judgment or not in step S8. When it is not the fourth judgment, the process proceeds to step S9, in which the control logic 260 adjusts the capacitance value in the filter circuit within the adjustment range (−20.0 to +17.5% in the embodiment) so that the capacitance calibration bit value is decreased by 2^{(3-m)} and changes over the switches SW1 to SW4, SW11 to SW14 and SW21 to SW24 in accordance with the adjustment result. m represents the judgement time value in table of FIG. 7. Concretely, after the first judgment, the capacitance value is made smaller by −10% than the capacitance value in the center of the design value.

Then, the process is returned to step S6 and the above procedure is repeated. When the process comes to step S9 even after the second judgment, the capacitance value in the filter circuit is set to be smaller by −15% than the capacitance value in the center of the design value. When the process comes to step S9 even after the third judgment, the capacitance value in the filter circuit is set to be smaller by −17.5% than the capacitance value in the center of the design value. Further, when the judgment result is “No” even in the fourth judgment of step S7, the process proceeds to step S10 after passing through step S8. In step S10, the capacitance value in the filter circuit is set to be smaller by −20% than the capacitance value in the center of the design value and becomes the minimum value within the adjustment range.

On the other hand, when the judgment result in step S7 is “Yes”, that is, when the detection output is high level, it is understood that the phase of the clock passing through the phase shifting circuit DPS is more lagged than the phase of the clock passing through the filters LPF11 to LPF14 as shown at time T2 of FIG. 6. In this case, the control logic 260 decides whether the above judgment in step S7 is the fourth judgment or not in step S11. When it is not the fourth judgment, the process proceeds to step S12, in which the control logic 260 adjusts the capacitance value in the filter circuit within the adjustment range (−20.0 to +17.5% in the embodiment) so that the capacitance calibration bit value is increased by 2^{(3-m)} and changes over the switches SW1 to SW4, SW11 to SW14 and SW21 to SW24 in accordance with the adjustment result. Concretely, after the first judgment, the capacitance value is made larger by +10% than the capacitance value in the center of the design value.

Then, the process is returned to step S6 and the above procedure is repeated. When the process comes to step S12 even after the second judgment, the capacitance value in the filter circuit is set to be larger by +15% than the capacitance value in the center of the design value. When the process comes to step S12 even after the third judgment, the capacitance value in the filter circuit is set to be larger by +17.5% than the capacitance value in the center of the design value. Further, when the judgment result is “Yes” in the fourth judgment of step S7, the process proceeds to step S13 after passing through step S11. In step S13, the capacitance value in the filter circuit selected in step S11 is set to be larger by +17.5% than the capacitance value in the center of the design value and becomes the maximum value within the adjustment range.

In the foregoing description, “No” or “Yes” is repeated continuously in the judgment of step S7, while when “No” and “Yes” are issued alternately in the judgment of step S7, any of 17.5%, 15%, 12.5%, 10%, 7.5%, 5%, 2.5%, 0%, −2.5%, −5%, −7.5%, −10%, −12.5%, −15% and −17.5% described in the rightmost column of FIG. 7 is set in order of the generation of “No” and “Yes”. When the capacitance value in the filter circuit is set as above, the process proceeds to step S14, in which supply of the reference clock CLK0 to the calibration circuit 214 is interrupted. Then, operation of the high-gain amplifier portions 220A, 220B and the mixers 212a, 212b is stopped to complete the calibration (step S15). After the calibration is completed, the calibration bit value is held in the register and the on and off state of the switches is also held until a next calibration is made.

Next, how to decide the characteristic of the low-pass filters LPF11 to LPF14, LPF21 to LPF 24 is described briefly.

When a wireless communication apparatus of the GSM system is designed, suppression level of disturbance wave to desired wave is stipulated in the GSM standards. Further, a minimum level of input signal to be received is also stipulated in the GSM standards. On the other hand, an output level produced by the high-frequency IC which makes down-conversion and demodulation of the reception signal and required by the baseband circuit is generally 50 mvpp in most cases, although the output level is different depending on the baseband LSI circuit used. Accordingly, the gain required by the receiving circuit is different depending on the baseband LSI circuit and the input signal of the minimum level stipulated in the GSM standards is required to be amplified to the level required by the baseband circuit on the way from the low-noise amplifier 210 at the first stage to the output terminal of the amplifiers AMP1, AMP2 at the final stage in the receiving circuit of FIG. 1, for example.

In the actual design, the gains of the low-noise amplifier 210, the mixers 212, the three gain control amplifiers PGA of the high-gain amplifier portions 220A, 220B and the amplifiers AMP1, AMP2 at the final stage are determined in consideration of balance of the whole circuit. When a desired wave having the minimum level of −99 dB, for example, is inputted, the gain of about 20 dB is set to a combination of the low-noise amplifier 210 and the mixer 212, the gain of 18 dB is set to each of the gain control amplifiers PGA1, PGA2 at the first and second stages, the gain of 4 dB is set to the gain control amplifier PGA3 at the third stage and the gain of 8 dB is set to the amplifiers AMP1, AMP2 at the final stage, so that the output of 50 mvpp required by the baseband circuit is obtained.

The characteristic required in the low-pass filters LPF of the high-gain amplifier portions 220A, 220B is that the level of disturbance wave can be suppressed to be smaller than the input dynamic range of the amplifiers AMP1, AMP2 at the final stage even in the most severe condition. More particularly, the most severe condition at the time that the input level of the desired wave is −99 dB is the case where disturbance wave of −23 dB and 3 MHz is inputted. At this time, disturbance wave having the level of about 2140 mVpp is inputted from the mixers 212a, 212b to the high-gain amplifier portions 220A, 220B. When it is supposed that the input dynamic range at the time that the gain of the gain control amplifier PGA1 at the first stage is 18 dB is about 135 mvpp, the low-pass filters LPF11, LPF21 at the first stage are required to suppress the disturbance wave (3 MHz) of about 2140 mVpp to 135 mvpp or less. The low-pass filters LPF12, LPF22, LPF13, LPF23 at the second stage et seq. are also required to be designed in consideration of characteristic of the succeeding circuit similarly.

In the high-gain amplifier portions 220A, 220B of the embodiment, the characteristic of the low-pass filters LPF11 to LPF 14 and LPF21 to LPF 24 are determined as above. Values of resistors and capacitors constituting the low-pass filter are determined in consideration of the filtering characteristic determined as above, chip area and noise figure (NF).

FIGS. 8A and 8B illustrate modification examples of a calibratable filter circuit suitable for the high-gain voltage amplifier portions of the embodiment. The filter circuit shown in FIG. 8A includes transistor amplifier circuits TACt, TACb, a differential amplifier AMP0 which is supplied with outputs of the transistor amplifier circuits TACt, TACb and variable capacitors C2t, C2b through which differential outputs of the differential amplifier AMP0 are fed back to input sides of the filter circuit.

The filter circuit shown in FIG. 8B includes differential amplifiers TACt, TACb instead of the transistor amplifier circuits TACt, TACb constituted by emitter followers and variable capacitors C2t, C2b and resistors R3t, R3b through which outputs of the differential amplifiers TACt, TACb are fed back to input sides of the filter circuit to thereby constitute a multi-feedback type filter circuit.

The whole configuration example of the wireless communication system using the high-frequency IC to which the high-gain voltage amplifier circuit having the calibration circuit of the embodiment is applied is now described.

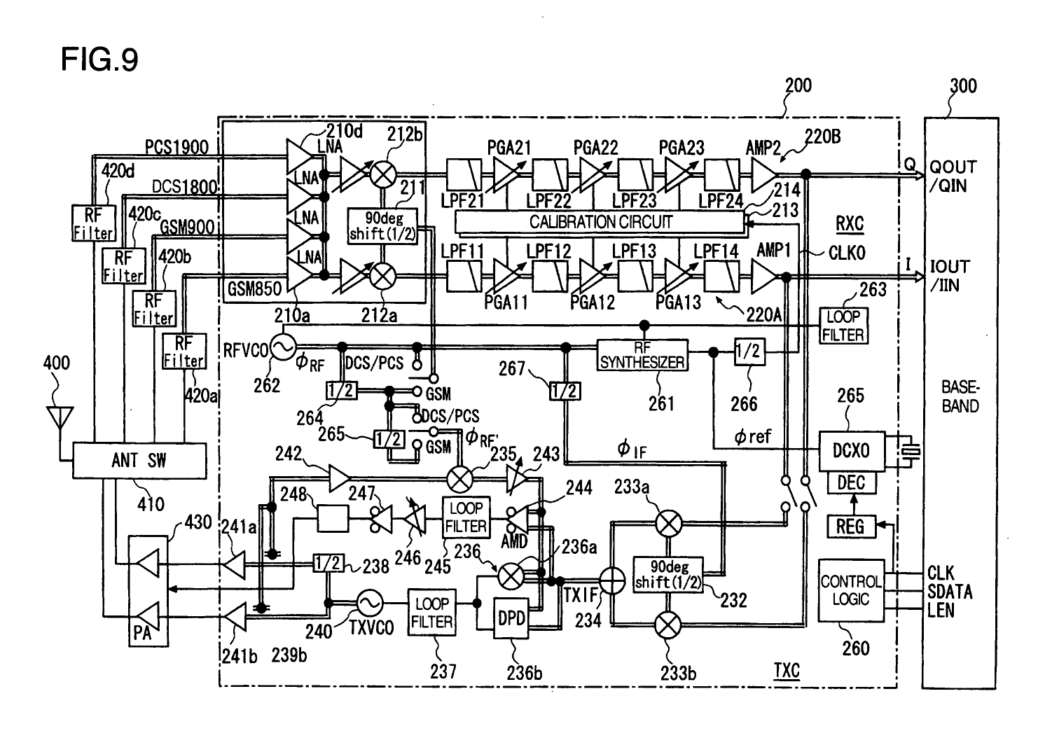

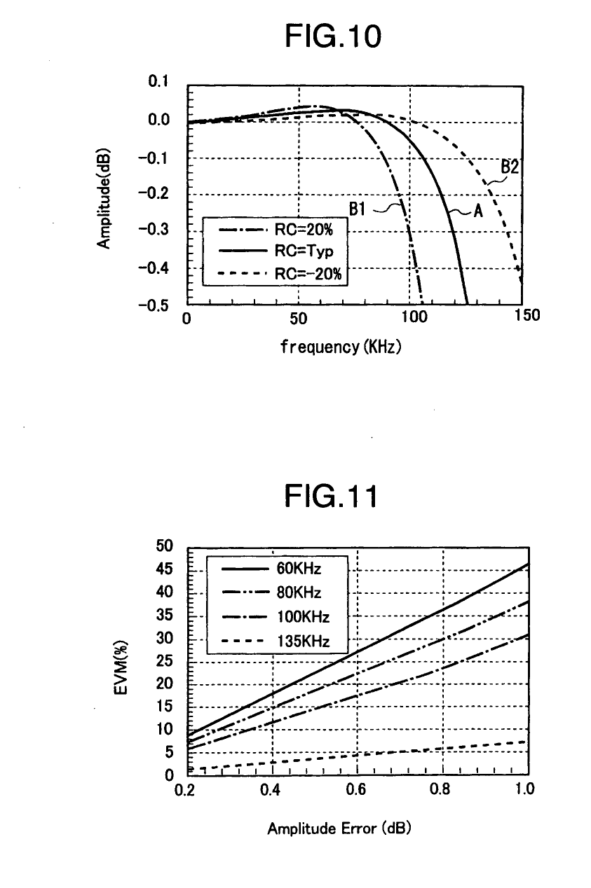

As shown in FIG. 9, the wireless communication system of the embodiment includes a transmitting/receiving antenna 400 of radio wave signal, a switch 410 which changes over the antenna to make transmission and reception of radio wave signal, band-pass filters 420a to 420d constituted by SAW filters which removes unnecessary waves from a received signal, a high-frequency power amplifier circuit (power module) 430 which amplifies a transmission signal, a high-frequency IC 200 which demodulates the received signal and modulates the transmission signal and a baseband circuit 300 which converts transmission data into I and Q signals and controls the high-frequency IC 200. In the embodiment, the high-frequency IC 200 and the baseband circuit 300 are formed on separate semiconductor chips as semiconductor integrated circuits.

Although not limited, the high-frequency IC 200 of the embodiment can modulate and demodulate signals in four frequency bands for the communication systems including GSM 850, GSM 900, DCS 1800 and PCS 1900. Further, the band-pass filters include a filter 420a which passes a received signal in the frequency band for GSM 850, a filter 420b which passes a received signal in the frequency band for GSM 900, a filter 420c which passes a received signal in the frequency band for DCS 1800 and a filter 420d which passes a received signal in the frequency band for PCS 1900.

The high-frequency IC 200 of the embodiment includes, when divided broadly, a receiving circuit RXC, a transmitting circuit TXC and a control circuit including other circuits common to the transmitting and receiving circuits such as a controller and a clock generator circuit.

The receiving circuit RXC includes low-noise amplifiers 210a to 210d which amplify received signals in the frequency bands for GSM 850, GSM 900, DCS 1800, PCS 1900, a frequency dividing and phase shifting circuit 211 which frequency-divides a local oscillation signal φRF generated by a high-frequency oscillation circuit (RFVCO) 262 to generate orthogonal signals having phases shifted by 90° from each other, mixer circuits 212a, 212b which mix the received signals amplified by the low-noise amplifiers 210a to 210d with the orthogonal signals generated by the frequency dividing and phase shifting circuit 211 to thereby make demodulation and down-conversion of I and Q signals, high-gain amplifier portions 220A, 220B which amplify demodulated I and Q signals, respectively, to be outputted to the baseband LSI circuit 300 and are common to each frequency band, an offset cancel circuit 213 which cancels input DC offsets in amplifiers of the high-gain amplifier portions 220A, 220B and the calibration circuit 214 described in the above-mentioned embodiment.

The control circuit includes a controller (control logic) 260 which controls the whole chip, a reference oscillation circuit (DCXO) 265 which generates a reference oscillation signal φref, a high-frequency oscillation circuit (RFVCO) 262 constituting a local oscillation circuit which generates a high-frequency oscillation signal φRF for frequency conversion, an RF synthesizer 261 constituting an RF-PLL circuit together with the high-frequency oscillation circuit (RFVCO) 262, a frequency dividing circuit 264 which frequency-divides the oscillation signal φRF generated by the high-frequency oscillation circuit (RFVCO) 262 to be supplied to the frequency dividing and phase shifting circuit 211 of the receiving circuit RXC, and a frequency dividing circuit 265 which frequency-divides the oscillation signal φRF generated by the high-frequency oscillation circuit (RFVCO) 262 to be supplied to a mixer 235 for down-conversion on a feedback path of the transmitting circuit TXC.

Further, the controller (control logic) 260 include a frequency dividing circuit 266 which frequency-divides the oscillation signal φRF generated by the reference oscillation circuit (DCXO) 265 and supplies it to the calibration circuit 214 as the reference clock CLK0 and a frequency dividing circuit 267 which frequency-divides the oscillation signal φRF generated by the high-frequency oscillation circuit (RFVCO) 262 and generates an intermediate frequency signal φIF which is supplied to a frequency dividing and phase shifting circuit 232 for orthogonal modulation in the transmitting circuit TXC. Further, since the reference oscillation signal φref is required to have high frequency accuracy, a crystal oscillation element is connected to the reference oscillation circuit 265 externally. A frequency such as 26 MHz or 13 MHz is selected as the reference oscillation signal φref. The crystal oscillation element for such a frequency is generally-used component and is available easily and inexpensively.

The high-frequency oscillation circuit (RFVCO) 262 is constituted by an LC resonance type oscillator circuit and a plurality of capacitance elements constituting the LC resonance circuit are disposed in parallel through switching elements, respectively. The switching elements are selectively turned on in accordance with a band change-over signal to change the capacitance elements connected to the LC resonance circuit, that is, a value of capacitance C of the LC resonance circuit so that the oscillation frequency can be changed over stepwise. The high-frequency oscillation circuit (RFVCO) 262 includes variable capacitance elements having capacitance values changed in accordance with a voltage supplied from a loop filter in the RF synthesizer 261 so that the oscillation frequency is changed continuously. The RF synthesizer 261 includes a variable frequency dividing circuit which frequency-divides the oscillation signal φRF generated by the high-frequency oscillation circuit (RFVCO) 262, a frequency dividing circuit which frequency-divides the reference oscillation signal φref, a phase comparison circuit which compares phases of the frequency-divided signals to detect a phase difference and a charging pump which produces a current in accordance with the phase difference and charges and discharges the loop filter. In the embodiment, the RF synthesizer 261 is a fractional synthesizer in which the variable frequency dividing circuit can frequency-divide the oscillation signal φRF of the high-frequency oscillation circuit (RFVCO) 262 in a frequency division ratio given by an integer and a fraction.

The transmitting circuit TXC includes a frequency dividing and phase shifting circuit 232 which frequency-divides the intermediate frequency signal φIF frequency-divided by the frequency dividing circuit 267 and generates orthogonal signals having phases shifted by 90° from each other, orthogonal modulation circuit 233a, 233b constituted by mixers which modulates the generated orthogonal signals by I and Q signals supplied from the baseband circuit 300, an adder 234 which combines the modulated signals, a transmission oscillation circuit (TXVCO) 240 which generates a transmission signal φTX having a predetermined frequency, an offset mixer 235 which combines a feedback signal extracted from the transmission signal φTX generated by the transmission oscillation circuit 240 by a coupler or the like with a signal φRF′ obtained by frequency-dividing the oscillation signal φRF generated by the high-frequency oscillation circuit (RFVCO) 262 to thereby generate a signal having a frequency corresponding to a frequency difference therebetween, a phase comparison circuit 236 which compares the output of the offset mixer 235 with a signal TXIF combined by the adder 234 to detect a frequency difference and a phase difference therebetween, a loop filter 237 which generates a voltage in accordance with an output of the phase comparison circuit 236, a frequency dividing circuit 238 which frequency-divides the output of the transmission oscillation circuit (TXVCO) 240 to generate a transmission signal of the GSM system, and buffer circuits 241a, 241b which convert a differential output into a single signal to be outputted. One of the buffer circuits 241a, 241b is a circuit which produces a signal in the band of 850 to 900 MHz for GSM and the other is a circuit which produces a signal in the band of 1800 to 1900 MHz for PCS.

Further, the transmitting circuit TXC includes an amplitude control loop composed of an attenuator or amplifier 242 which attenuates or amplifies the feedback signal taken out from the output side of the transmission oscillation circuit (TXVCO) 240 to be supplied to the offset mixer 235, a variable gain amplifier 243 which amplifies the attenuated or amplified feedback signal, an amplitude comparison circuit 244 which compares an output signal of the variable gain amplifier 243 with the transmission signal TXIF combined by the adder 234 to detect an amplitude difference, a loop filter 245 which limits a band of an output of the amplitude comparison circuit 244, a variable gain amplifier 246 which amplifies the band-limited signal, a voltage-to-current conversion circuit 247 which converts the amplified voltage of the amplitude control loop into a current and a filter 248 which converts the current into a voltage, so that the transmitting circuit TXC can cope with the EDGE mode in which amplitude modulation and phase modulation are made.

An amplitude control voltage is supplied through the filter 248 to the power module 430 as a voltage for controlling an amplification factor. Although not shown, the feedback signal supplied to the offset mixer 235 may be taken out from the output side of the power module 430 instead of being taken out from the output side of the transmission oscillation circuit (TXVCO) 240. The variable gain amplifiers 243 and 246 are controlled so that when the gain of one of them is increased the gain of the other is reduced by the same value in absolute value and when the gain of the one is reduced, the gain of the other is increased by the same value in absolute value.

Further, although not limited, in the embodiment, the phase comparison circuit 236 of PLL in the transmitting system includes an analog phase comparison circuit 236a having high accuracy and a digital phase comparison circuit 236b having high operation speed, which are connected in parallel. In the beginning of operation, the digital phase comparison circuit having high operation speed is operated and after the phase are substantially coincident, the analog phase comparison circuit having high accuracy is operated, so that pulling-in operation in the beginning of operation of the PLL circuit can be made rapidly with high accuracy.

Further, the controller 260 in the high-frequency IC of the embodiment is supplied with the clock signal CLK for synchronization, a data signal SDATA and a load enable signal LEN as a control signal from the baseband IC 300. When the load enable signal LEN is changed to an effective level, the controller 260 successively takes in the data signal SDATA transmitted from the baseband IC 300 in synchronism with the clock signal to be set in the control register and generates a control signal supplied to the circuits in the IC in accordance with the contents set in the control register. Although not limited, the data signal SDATA is transmitted serially. The data signal SDATA contains a command supplied from the baseband IC 300 to the high-frequency IC 200.

In the wireless communication system of the multi-band system of the embodiment, the controller 260 changes the frequency φRF of the oscillation signal of the high-frequency oscillation circuit 262 in accordance with a used channel in response to a command from the baseband IC 300, for example, upon transmission and reception and changes the frequency of the signal supplied to the offset mixer 235 in accordance with GSM mode or DCS/PCS mode to thereby change over the transmission frequency.

On the other hand, the oscillation frequency of the high-frequency oscillation circuit (RFVCO) 262 is set to a value different depending on the reception mode or the transmission mode. The oscillation frequency fRF of the high-frequency oscillation circuit (RFVCO) 262 is set to, for example, 3616 to 3716 MHz in GSM 850, 3840 to 3980 MHz in GSM 900, 3610 to 3730 MHz in DCS 1800 and 3860 to 3980 MHz in PCS 1900 in the transmission mode and is frequency-divided to ¼ in GSM and ½ in DCS and PCS by the frequency dividing circuit to be supplied to the mixer 235.

The high-frequency IC 200 of the embodiment can be mounted on a single insulating substrate made of ceramic together with a crystal oscillation element connected externally to form a module of a discrete electronic component. Further, the filters 420a to 420d may be mounted on the ceramic substrate in which the high-frequency IC 200 and the crystal oscillation element are mounted to form a module.

The present invention made by the inventor has been described concretely with reference to the embodiment, although the present invention is not limited thereto. In the embodiment, for example, the filter circuits at the second to fourth stages of the high-gain voltage amplifier circuit use the second-order Sallen-key filter having the filtering characteristic of a cut-off frequency fc expressed by fc=½√(R1·R2·C1·C2), although the configuration of the used filters is not limited thereto and may be any configuration as far as an active filter using an active element is used. Further, the order of the filter is not limited to the second-order and may be the third-order or higher.

Moreover, in the embodiment, the high-frequency IC constituting the wireless communication system includes the receiving circuit and transmitting circuit formed on a single semiconductor chip, although the present invention can be applied to the high-frequency IC including the receiving circuit and the transmitting circuit formed on separate semiconductor chips. Further, in the embodiment, the present invention is applied to the high-frequency IC which can cope with the EDGE mode in which the phase modulation and the amplitude modulation are made, although the present invention can be also applied to the high-frequency IC which can cope with the W-CDMA system to thereby obtain the same effects.

In the foregoing description, the present invention made by the inventor is applied to the high-frequency IC used in the wireless communication systems such as portable telephones in the utilization field of the background, although the present invention is not limited thereto and the present invention can be also applied to the high-frequency IC for radio LAN, the semiconductor integrated circuit including the high-gain amplifier circuit which amplifies a high-frequency signal and the like generally.

1. A communication semiconductor integrated circuit comprising:
a demodulation circuit for combining a received signal subjected to phase modulation and amplitude modulation with a high-frequency oscillation signal having a predetermined frequency to generate a demodulated signal;
a serial-signal processing circuit connected to said demodulation circuit and including a plurality of low-pass filters and a plurality of variable gain amplifier circuits cascade-connected alternately in series, said serial-signal processing circuit having predetermined high-frequency attenuation characteristic; and
a calibration circuit for measuring a deviation between a target value of the high-frequency attenuation characteristic to be calibrated as a whole of said serial-signal processing circuit and the high-frequency attenuation characteristic at time that said serial-signal processing circuit is operated actually and setting constants of elements constituting said serial-signal processing circuit so that said deviation is reduced.

2. A communication semiconductor integrated circuit comprising:
a frequency conversion circuit for combining a received signal subjected to phase modulation and amplitude modulation with a high-frequency oscillation signal having a predetermined frequency to down-convert said received signal into a signal in a predetermined frequency band;
a serial-signal processing circuit connected to said frequency conversion circuit and including a plurality of low-pass filters and a plurality of variable gain amplifier circuits cascade-connected alternately in series, said serial-signal processing circuit having predetermined high-frequency attenuation characteristic; and
a calibration circuit for measuring a deviation between a target value of the high-frequency attenuation characteristic to be calibrated as a whole of said serial-signal processing circuit and the high-frequency attenuation characteristic at time that said serial-signal processing circuit is operated actually and calibrating constants of elements constituting said serial-signal processing circuit so that said deviation is reduced.

3. A communication semiconductor integrated circuit according to claim 2, wherein
said elements having the constants calibrated by said calibration circuit are capacitance elements constituting said low-pass filters and said low-pass filters each include variable capacitance circuits each including a plurality of capacitance elements and switching elements connected in series to said capacitance elements, respectively, on and off states of said switching elements being set in accordance with a signal from said calibration circuit to thereby make calibration.

4. A communication semiconductor integrated circuit according to claim 3, wherein
said respective variable capacitance circuits constituting said low-pass filters have the same configuration and said variable capacitance circuits each are set so that the on and off states of said switching elements are identical on the basis of the signal from said calibration circuit.

5. A communication semiconductor integrated circuit according to claim 2, wherein
said calibration circuit measures a delay value of a signal passing through said serial-signal processing circuit and calibrates the constants of the elements constituting said serial-signal processing circuit so that a difference between said measured delay value and a target delay value is reduced.

6. A communication semiconductor integrated circuit according to claim 5, wherein
said calibration circuit includes a signal delay circuit for delaying a reference clock having a predetermined period by said target delay value of said serial-signal processing circuit and the same reference clock is caused to pass through said signal delay circuit and said serial-signal processing circuit to compare signals passing through both said circuits so that the constants of the elements constituting said serial-signal processing circuit are calibrated so that delay values of the signals are equal to each other.

7. A communication semiconductor integrated circuit according to claim 6, wherein
said calibration circuit includes a waveform shaping circuit for shaping waveforms of a signal passing through said serial-signal processing circuit and a signal passing through said signal delay circuit and a phase comparison circuit for detecting a phase difference of the signals having the waveforms shaped by said waveform shaping circuit, and said calibration circuit calibrates the constants of the elements constituting said serial-signal processing circuit so that the delay values are equal to each other on the basis of an output of said phase comparison circuit.

8. A communication semiconductor integrated circuit according to claim 7, comprising
a control circuit for successively changing the on and off states of said switching elements constituting said variable capacitance circuit on the basis of the output of said phase comparison circuit and calibrating the constants of the elements constituting said serial-signal processing circuit so that the delay value of the signal passing through said serial-signal processing circuit gradually approaches to the delay value of the signal passing through the signal delay circuit.

9. A communication semiconductor integrated circuit according to claim 8, wherein
said calibration circuit includes a decoder circuit for generating on and off information for said switching elements on the basis of the signal from said control circuit.

10. A communication semiconductor integrated circuit according to claim 9, wherein
said calibration circuit includes a register for holding an output of said decoder circuit.

11. A communication semiconductor integrated circuit according to claim 1, wherein
said elements having the constants calibrated by said calibration circuit are capacitance elements constituting said low-pass filters and said low-pass filters each include variable capacitance circuits each including a plurality of capacitance elements and switching elements connected in series to said capacitance elements, respectively, on and off states of said switching elements being set in accordance with a signal from said calibration circuit to thereby make calibration.

12. A communication semiconductor integrated circuit according to claim 1, wherein
said calibration circuit measures a delay value of a signal passing through said serial-signal processing circuit and calibrates the constants of the elements constituting said serial-signal processing circuit so that a difference between said measured delay value and a target delay value is reduced.
